(19) United States
(12) Patent Application Publication
(10) Pub. No.: US 2013/0105646 A1
(43) Pub. Date: May 2, 2013

(54) Space-Saving Flat Screen Television Stand

(71) Applicant: Timothy Owens, Manistee, MI (US)

(72) Inventor: Timothy Owens, Manistee, MI (US)

(21) Appl. No.: 13/664,030

(22) Filed: Oct. 30, 2012

Related U.S. Application Data
(60) Provisional application No. 61/553,411, filed on Oct. 31, 2011.

(51) Int. Cl. F16M 13/02

(52) U.S. Cl. 248/205.1

(57) ABSTRACT

A flat screen television stand comprising a non-freestanding base pole adapted to be secured temporarily in upright fashion to a furniture support, and an inner pole telescopically and rotatably mounted in the base pole with its lower end resting on a transverse height adjustment pin in the base pole. The upper end of the inner pole is adapted to mount a flat screen television essentially tangentially to the pole. The flat screen television can be adjusted rotationally with hand pressure, without tools, but resists unintentional movement to maintain its adjusted position.

### RELATED APPLICATIONS/PRIORITY BENEFIT CLAIM

This application claims the benefit of U.S. Provisional Application No. 61/553,411, filed Oct. 31, 2011 by the same inventor (Owens), the entirety of which provisional application is hereby incorporated by reference.

### FIELD

The subject matter of the present application is in the field of stands for flat screen televisions and similar electronic displays.

### BACKGROUND

Flat screen televisions are often mounted on walls, using brackets fastened directly to the walls. There are circumstances, however, where wall mounting is not practical or not permitted, for example where no suitable studs can be found for support, or in dorm rooms, apartments, or anywhere the building owner does not want the character or structure of the walls altered. Wall mounting also limits the adjustability of the screen's position relative to viewers in the room, and may not be practical in small rooms crowded with furniture.

It is also known to mount flat screen televisions and similar displays on furniture such as workstations and desks. Movable desktop stands are familiar to most computer users and flat screen television owners.

U.S. Pat. No. 5,401,089 (Inagaki et al.) and U.S. Pat. No. 7,530,538 (Whalen et al.) show two examples of more permanently-affixed flat screen stands for desks and tables. Although height adjustable, these types of supports appear to be intended as essentially permanent fixtures on relatively low, desk- or table-type furniture for positioning the screen close to the desktop or tabletop; they appear to be relatively complex and expensive; and they appear to be limited to fixed viewing positions. They do not seem to be well designed for portability or for temporary locations, or for general recreational viewing by multiple people in a room who might frequently change viewing positions or angles, or for small, crowded rooms where there is little free space or uncluttered furniture surface for mounting a television.

### BRIEF SUMMARY

I have invented a simple to use, inexpensive, effective flat screen television display stand. The stand is especially useful for temporary mounting locations and/or where floor and wall space is taken up or obstructed by furniture of various types. The stand securely supports a flat screen relatively high off the ground, independent of free wall space, floor space, or available furniture surface, and offers the utmost in simplicity in terms of tool-free adjustment to different viewing positions.

The stand comprises an essentially straight, non-freestanding upright base pole adapted to be secured vertically to a piece of furniture or existing structural feature in the room (hereafter “furniture”). An essentially straight inner pole is mounted to slide up and down and to rotate inside the base pole, with the bottom of the inner pole resting and rotating on a height-adjustment pin passing through the base pole. The upper end of the inner pole extends beyond the base pole and includes a flat screen attachment means, such as a bracket, for attaching a flat screen essentially tangentially to the pole. The height-adjustment pin can be moved to multiple height positions on the base pole to adjust the height of the inner pole (and an attached flat screen) relative to the base pole.

When a flat screen is mounted at the upper end of the inner pole, hand or finger pressure on the screen has been found sufficient to rotate the screen to a different viewing position. It has further been found that no locking means are required to rotationally secure the screen/inner pole combination once adjusted—the weight of the flat screen on the height-adjustment pin through the inner pole provides sufficient friction to hold the flat screen in place in its adjusted position, without movement due to normal room vibrations, air currents, and the like.

“Flat screen” is used herein to mean flat screen LCD or plasma type televisions, or any similar or equivalent large, relatively flat, multi-viewer electronic display screen devices.

These and other features and advantages of the invention will become apparent from the detailed description below, in light of the accompanying drawings.

### BRIEF DESCRIPTION OF THE DRAWINGS

FIG. 1 is a perspective view of an exemplary flat screen television stand according to the invention, secured to a piece of furniture in a room.

FIG. 2 is a detail perspective view of the stand of FIG. 1, with the base pole partially cut away at the junction of the inner pole and the height adjustment pin.

FIGS. 3A, 3B and 3C are perspective views of the stand of FIG. 1, each Figure showing a different height adjustment using the inner pole.

FIG. 4 is an exploded assembly view of the stand of FIG. 1.

### DETAILED DESCRIPTION

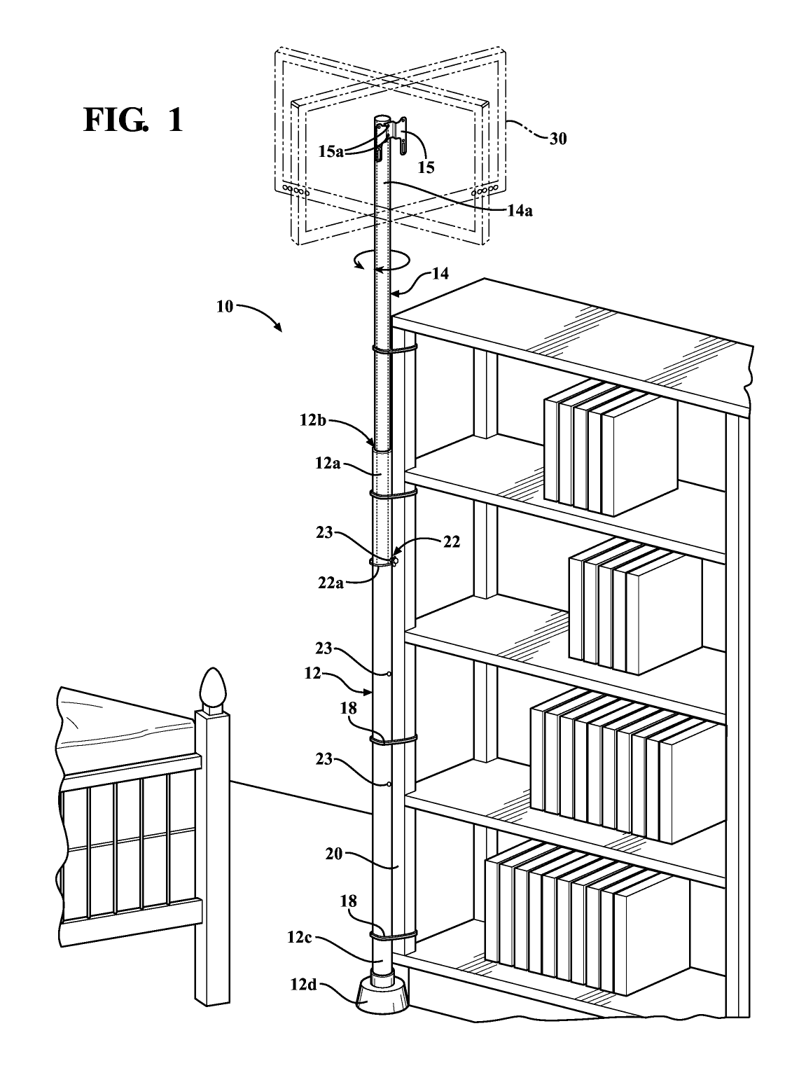

Referring first to FIG. 1, a flat screen television stand 10 is shown in exemplary form in order to teach how to make and use the claimed invention. “Flat screen television” will generally be abbreviated “flat screen” or “screen” for convenience.

Stand 10 has a base pole 12 adapted to be secured to an existing support 20 that is spaced from the room's walls, such as a piece of sturdy furniture (desk, bed frame, bunk bed frame, cabinet, bookshelf, etc., without limitation), or a structural feature of the room (e.g., a support column) that offers a secure mounting location spaced from the walls. Support 20 should have sufficient height and strength to support the weight of stand 10 and a flat screen 30 mounted on the stand's upper end.

More specifically, stand 10 is secured in parallel to a more-or-less vertical portion (or vertical series of portions) of a piece of furniture (post, beam, leg, etc., without limitation) capable of receiving wraparound securing means. In the illustrated example, stand 10 is removably secured to a vertical post or leg of a bookshelf 20 with securing means 18, for example self-locking plastic cable ties 18 of known type. Other types of securing means 18 could be used, including but not limited to non-marring, non-invasive wraparound means such as bungee cords, rope, wire, straps, C-clamps, duct tape and the like that pass around or engage the outside surfaces of the base pole 12 and the support 20. It would also be possible, although less desirable, to use mechanical fasteners such as screws or bolts passing through the base pole 12 and into the support 20, either independently of any wraparound securing means or to supplement the wraparound securing means.

Base pole 12 has an upper end 12a with an open hollow bore 12b, and a lower end 12c adapted to rest on the floor. The lower end 12c may have a non-freestanding base 12d with a non-slip or non-mar finish, and/or with a diameter greater than the base pole, to spread forces and to reduce the compression or marking of carpet and other sensitive floor surfaces. Base 12d is not sufficient to support stand 10 on its own, as the diameter of the base would have to be prohibitively wide given the height of stand 10 (on the order of five to eight feet high) and the weight of flat screen 30 in order to be freestanding.

Base pole 12 may be made from any material suitably rigid and strong enough to support the remainder of the stand and a flat screen, including but not limited to plastic and metal materials. In the illustrated example, base pole 12 is made from four-inch diameter thick-walled PVC-type plastic pipe.

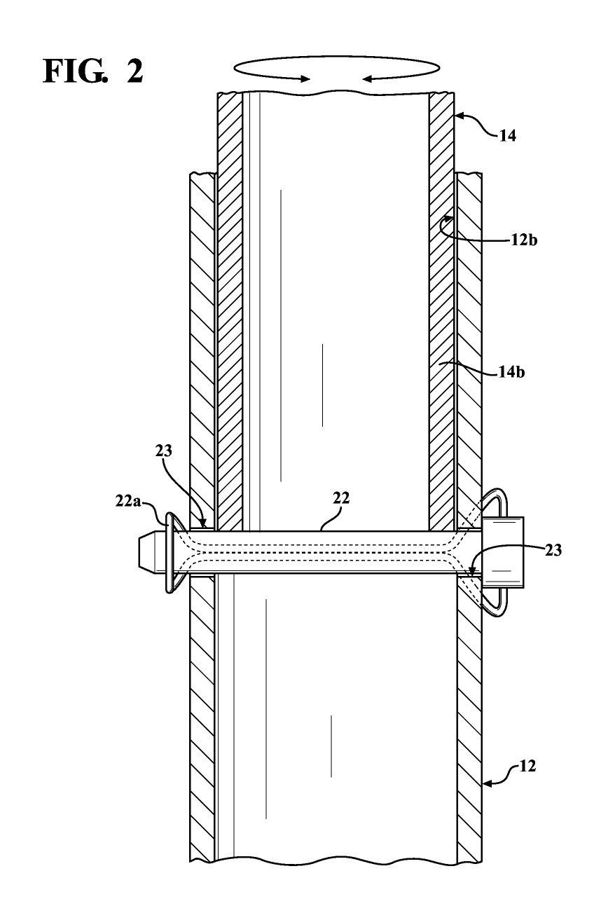

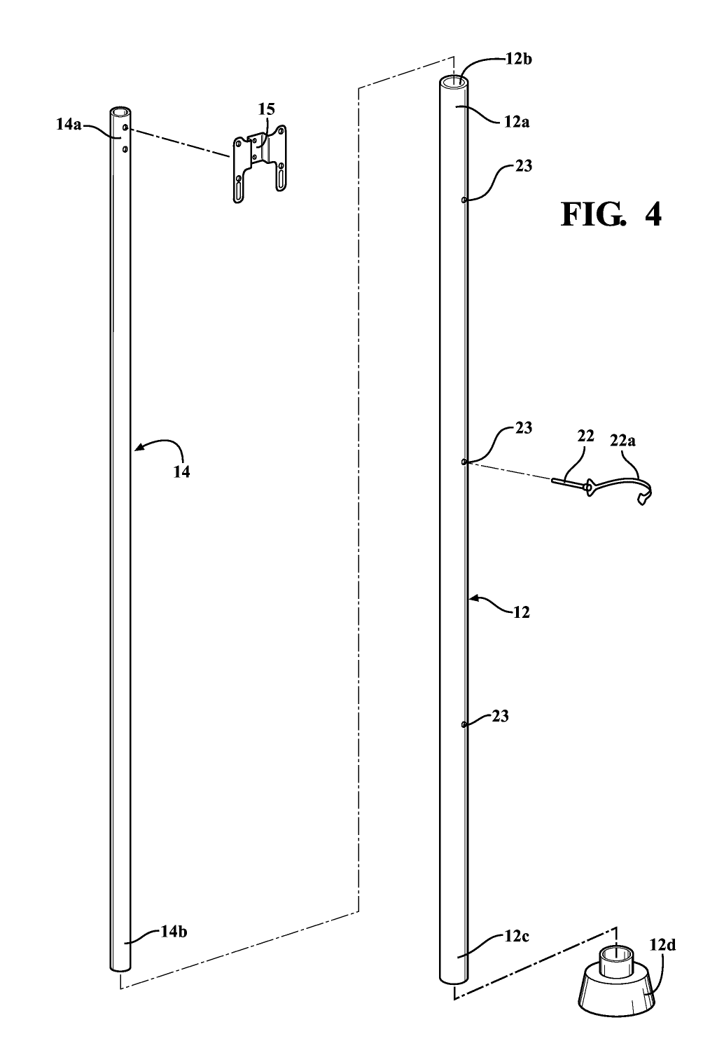

Stand 10 also includes an inner adjustable pole 14 of smaller diameter than base pole 12, mounted inside base pole 12 to telescope and to rotate. In the illustrated example, inner pole 14 is made from the same material as base pole 12, although it could be made from a different material. Inner pole 14 may be solid or hollow, but in the illustrated example it is hollow to reduce weight. Inner pole 14 has a lower end 14b (FIGS. 2 and 4) supported above the ground inside base pole 12, and an upper end 14a extending above the upper end of base pole 12.

Upper end 14a of inner pole 14 supports a flat screen 30 of known, commercially available type, and of nearly any suitable multi-viewer size. Flat screen 30 could be directly fastened to pole 14, but in the preferred, illustrated example, upper end 14a of the pole is provided with attachment means 15 adapted specially to receive and secure a flat screen 30 tangentially to the surface of pole 14. In the illustrated example, attachment means 15 schematically represents a bracket of known and commercially available type, normally used for mounting a flat screen television directly to a wall; the style and size of the bracket may vary according to the make and model of the flat screen 30. Bracket 15 is secured to the upper end 14a of pole 14, for example with screws or bolts 15a. Bracket 15 is adapted to be connected to flat screen 30 with appropriate fasteners or mounting hardware, such as bolts or screws normally supplied with the bracket and adapted for a particular make and model of flat screen.

It should also be possible to mold, form, machine, or otherwise modify the upper end 14a of pole 14 to directly receive and mount a flat screen 30 tangentially to the pole, with or without fasteners.

Flat screen 30 is shown removably attached to upper end 14a of pole 14 via bracket 15, but it should also be possible to more or less permanently mount a flat screen to pole 14. The essentially tangential mounting of the screen relative to the pole (as close as practical to the surface of the pole and the axis of the stand) keeps moment forces to a minimum, and reduces the space taken up by the stand and flat screen combination relative to the room and furniture.

Referring to FIG. 2, the lower end 14b of inner pole 14 rests above the ground on a height adjustment pin 22 in base pole 12. Height adjustment pin 22 is inserted through an aligned pair of holes 23 formed in base pole 12. Pin 22 may be a clevis-type pin secured in place with a spring clip 22a engaging both ends of the pin as shown. Alternately, and without limitation, pin 22 may be a straight pin, a cotter pin, or a pin secured with a stop, detent or other structure on the pin and/or on base pole 12.

While pin 22 is shown as a removable height adjustment pin, capable of being mounted at two or more different heights above the ground in base pole 12, it could also be a fixed pin if stand 10 were intended for fixed-height use. In the illustrated example, three sets of holes 23 are shown, for three height adjustments.

As shown by the arrows in FIG. 2, inner pole 14 rests on pin 22 for rotation thereon within base pole 12. Pole 14 rotates freely, except for the frictional force between the mating surfaces of inner pole 14 and pin 22. In the illustrated example, pin 22 has a round cross-section for ease of rotation, but other cross-sections including polygonal shapes providing flat or point contact with the base of pole 14 are possible. The fit of inner pole 14 inside base pole 12 is preferably close enough to keep the axis of pole 14 aligned with the axis of pole 12, but without excessive friction between the sidewall surfaces of the poles. It would be possible to adjust the fit so that more or less friction exists between the sidewalls of the poles, depending on the relative ease of rotation desired relative to the base pole. Base pole 12 may also be provided with a cap or journal on its upper end, the cap having a hole sized to center inner pole 14 relative to the upper end of the bore in pole 12 while still allowing pole 14 to rotate.

In use it has been found that the combined weight of inner pole 14 and an attached flat screen 30 provides sufficient friction on pin 22 to “lock” the rotated pole/screen assembly against unintended movement due to room vibrations, air currents, and light cleaning such as dusting or wiping the screen. At the same time, the pole/screen assembly 14/30 is easily rotated by hand to any viewing position not blocked by nearby furniture or walls. If desired, however, additional rotational locking means such as set screws or clamping collars could be provided to prevent any rotation once flat screen 30 is in a desired position.

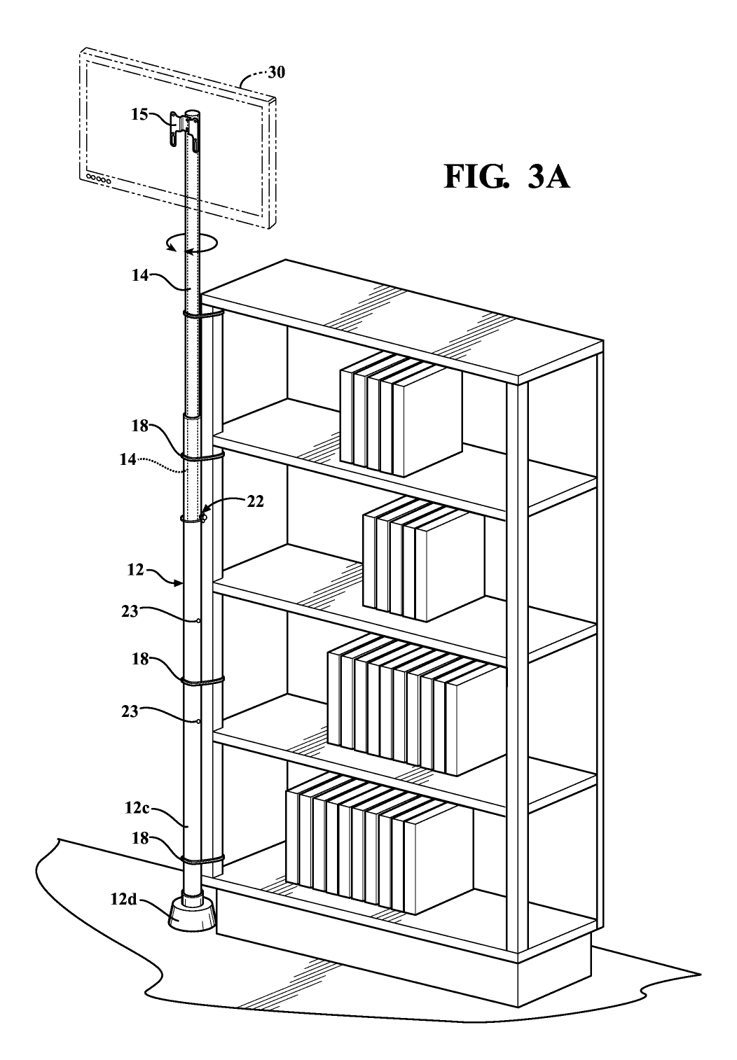

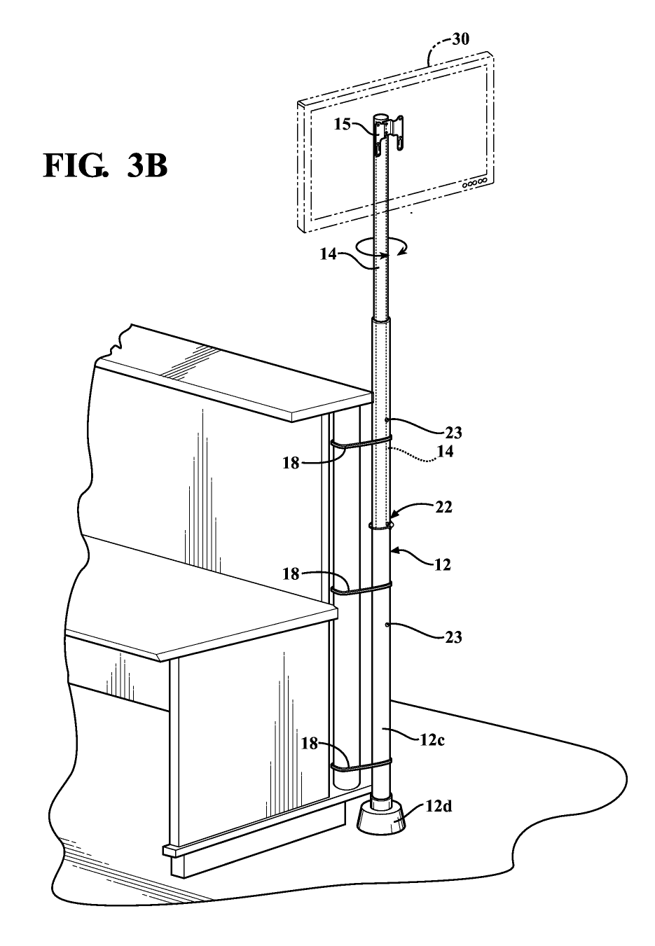

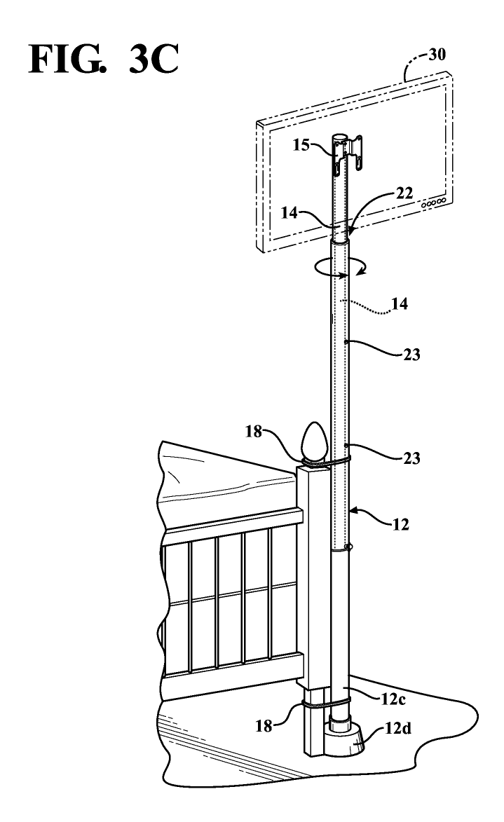

Referring next to FIGS. 3A through 3C, stand 10 is shown adjusted to three different heights corresponding to the heights of three different furniture supports 20. Height adjustment is accomplished by lifting or removing inner pole 14 to take its weight off pin 22 (if the pin is already inserted in pole 12), unlocking and removing pin 22 from holes 23, and re-inserting pin 22 in a different set of holes 23. Inner pole 14 (and the attached flat screen 30) can then be lowered or re-inserted in base pole 12 until pole 14 rests on pin 22 at the new height.

Stand 10 allows mounting flat screen 30 lower than, even with, or higher than the height of the adjacent furniture support 20, for maximum flexibility. The tangentially-mounted flat screen 30 can be swiveled around the support 20, limited only by adjacent furniture or room structure. While at least the base pole 12 should be secured to support 20 with securing means 18, it may be desirable to secure portions of the extended inner pole 14 to support 20 where the height of stand 20 is coextensive with the height of support 20.

Referring to FIG. 4, it should be appreciated that stand 10 can be disassembled for storage or moving. Bracket 15 can be removed from the upper end of inner pole 14; inner pole 14 can be removed from base pole 12, and base 12d can be removed from the lower end of base pole 12. It also should be possible to form base pole 12 and/or inner pole 14 in multiple sections for even more compactness when disassembled.

It will finally be understood that the disclosed embodiments represent presently preferred examples of how to make and use the invention, but are intended to enable rather than limit the invention. Variations and modifications of the illustrated examples in the foregoing written specification and drawings may be possible without departing from the scope of the invention. It should further be understood that to the extent the term “invention” is used in the written specification, it is not to be construed as a limiting term as to number of claimed or disclosed inventions or discoveries or the scope of any such invention or discovery, but as a term which has long been conveniently and widely used to describe new and useful improvements in science and the useful arts. The scope of the invention should accordingly be construed by what the above disclosure teaches and suggests to those skilled in the art, and by any claims that the above disclosure supports in this application or in any other application claiming priority to this application.

What is claimed:

1. A stand for a flat screen display, comprising:
a base pole of a first greater diameter, the base pole comprising a lower end adapted to rest on the ground, and a bore with an open upper end;
a height adjustment pin transversely mounted through the base pole and the bore;
an inner pole of a second smaller diameter, the inner pole comprising a lower end in the bore of the base pole and resting on the height adjustment pin, the inner pole slidable up and down and rotatable within the base pole on the height adjustment pin, the inner pole further comprising an upper end extending above the base pole, the inner pole further comprising attachment means adapted to mount a flat screen display to the upper end of the inner pole; and,
securing means for securing the base pole in an upright position to a furniture support.

2. The flat screen display stand of claim 1, wherein the attachment means is adapted to mount a flat screen display essentially tangentially to the upper end of the inner pole.

3. The flat screen display stand of claim 1, further comprising a flat screen display essentially tangentially mounted to the upper end of the inner pole.

4. The flat screen display stand of claim 1, wherein the base pole is not freestanding.
